(19) United States
(12) Patent Application Publication
(10) Pub. No.: US 2011/0074745 A1
(43) Pub. Date: Mar. 31, 2011

(54) DRIVING CIRCUIT FOR DISPLAY DEVICE AND METHOD FOR DRIVING THE SAME

(76) Inventors: Kuk-Hui CHANG, Paju-si (KR); Young-Nam Lee, Paju-si (KR)

(21) Appl. No.: 12/890,558

(22) Filed: Sep. 24, 2010

(30) Foreign Application Priority Data
Sep. 25, 2009 (KR) 10-2009-0091235

(51) Int. Cl. G06F 3/038

(52) U.S. Cl. 345/204

(57) ABSTRACT

A data driving circuit for a display panel, the data driving circuit including a driving integrated circuit including a plurality of data driving units configured to supply image data through a plurality of data link lines to data lines of the display panel and including a driving control unit configured to generate a source output enable signal for determining output timings of the image data from the data driving units; and a package body including a mount region in which the driving integrated circuit is mounted. Further, the driving control unit is further configured to first supply the source output enable signal to a corresponding data driving unit connected to a corresponding data link line having a greatest length among the data link lines such that the corresponding data driving unit outputs the image data earlier than other data driving units.

This application claims the benefit of Korean Patent Application No 10-2009-0091235, filed on Sep. 25, 2009, which is hereby incorporated by reference as if fully set forth herein.

### BACKGROUND OF THE INVENTION

1. Field of the Invention

The present invention relates to a driving circuit for a display device and corresponding method for minimizing a luminance deviation between pixels located on a central portion of the display device and pixels located on both ends of the display device by sequentially outputting image data from a data driving unit connected to data link lines having a relatively high resistance to a data driving unit connected to data link lines having a relatively low resistance.

2. Discussion of the Related Art

A driving integrated circuit includes a plurality of data driving units for supplying image data to data lines in a panel. In more detail, the data driving units output the image data through a plurality of data link lines formed in a non-display unit of panel. However, there exists distortion between the image data output from the data driving units. Thus, the image quality is deteriorated.

### SUMMARY OF THE INVENTION

Accordingly, one object of the present invention is to provide a driving circuit for a display device and corresponding method for driving the same that substantially obviate one or more problems due to limitations and disadvantages of the related art.

Another object of the present invention is to provide a driving circuit for a display device that minimizes a luminance deviation between pixels located on a central portion of a display unit and pixels located on both ends of the display unit by sequentially outputting image data from a data driving unit connected to data link lines having a relatively high resistance to a data driving unit connected to data link lines having a relatively low resistance.

To achieve these objects and other advantages and in accordance with the purpose of the invention, as embodied and broadly described herein, the present invention provides in one aspect a data driving circuit for a display panel, the data driving circuit including a driving integrated circuit (D-IC) including a plurality of data driving units (DDUs) configured to supply image data through a plurality of data link lines to data lines of the display panel and including a driving control unit (DCU) configured to generate a source output enable signal (SOE) for determining output timings of the image data from the data driving units (DDUs); and a package body (TCP) including a mount region (MD) in which the driving integrated (D-IC) circuit is mounted. Further, the driving control unit is further configured to first supply the source output enable signal (SOE) to a corresponding data driving unit (DDU) connected to a corresponding data link line having a greatest length among the data link lines such that the corresponding data driving unit outputs the image data earlier than other data driving units. The present invention also provides a corresponding display device.

In still another aspect, the present invention provides a method of driving a display device having a display panel including a non-display unit and a display unit and including a plurality of data and gate lines interesting each other, the method including supplying, via a plurality of data driving units (DDUs), image data through a plurality of data link lines to the data lines of the display panel; and generating, via a driving control unit (DCU) including a driving integrated circuit (D-IC) and a package body (TCP) including a mount region (MD) in which the driving integrated (D-IC) circuit is mounted, a source output enable signal (SOE) for determining output timings of the image data from the data driving units (DDUs); and first supplying the source output enable signal (SOE) to a corresponding data driving unit (DDU) connected to a corresponding data link line having a greatest length among the data link lines such that the corresponding data driving unit outputs the image data earlier than other data driving units.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram showing a display device including a driving circuit according to an embodiment of the present invention;

FIG. 2 is a diagram showing a driving integrated circuit of FIG. 1 in detail;

FIG. 3 is a diagram showing a driving integrated circuit according to an embodiment of the present invention; and

FIGS. 4A and 4B are diagrams showing a driving control unit and data driving units of FIG. 3 in detail.

### DETAILED DESCRIPTION OF THE INVENTION

Reference will now be made in detail to the preferred embodiments of the present invention, examples of which are illustrated in the accompanying drawings.

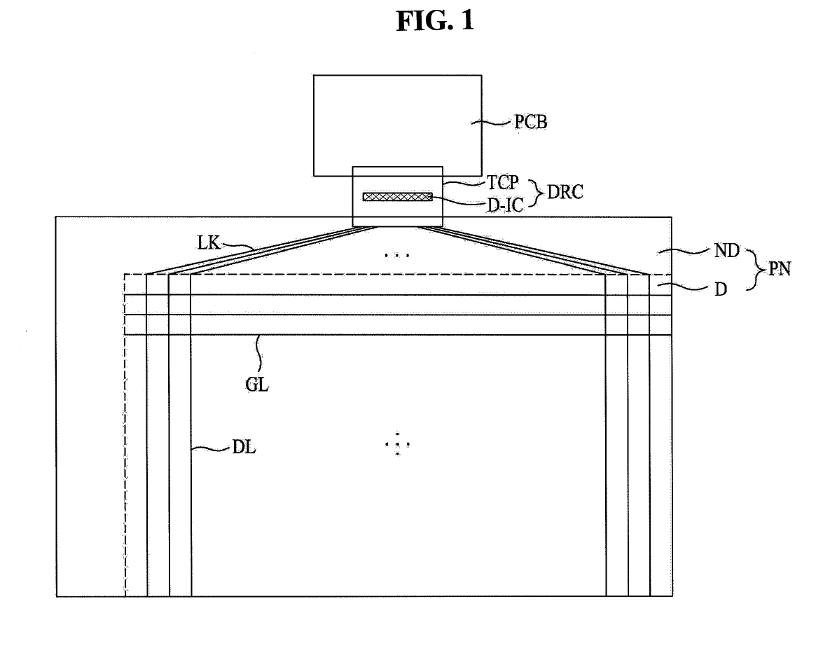

FIG. 1 is a diagram showing a display device including a driving circuit (DRC) according to an embodiment of the present invention. As shown, the display device includes a panel PN including a display unit D for displaying an image and a non-display unit ND surrounding the display unit D. The panel PN may be a panel including liquid crystal, a panel including an organic light-emitting diode, or the like.

Also included is a driving circuit DRC having a driving integrated circuit D-IC for generating various signals used to display the image on the display unit D of the panel PN and a surface mounted type package TCP in which the driving integrated circuit D-IC is mounted. A tape carrier package may be used as the surface mounted type package TCP.

Further, as shown, one side of the driving circuit DRC is connected to a Printed Circuit Board (PCB) and the other side of the driving circuit DRC is connected to the non-display unit ND. The PCB is also connected to an external system that supplies image data and various control signals to the driving circuit DRC through the PCB.

In addition, the display unit D includes a plurality of gate lines GL and data lines DL, which intersect each other, and pixels for displaying the image according to gate signals from the gate lines GL and image data from the data lines DL. Also, the non-display unit ND includes a plurality of data link lines for transmitting the image data from the driving circuit DRC to the data lines DL and a plurality of data link lines for transmitting the gate signals from the driving circuit DRC to the gate lines GL.

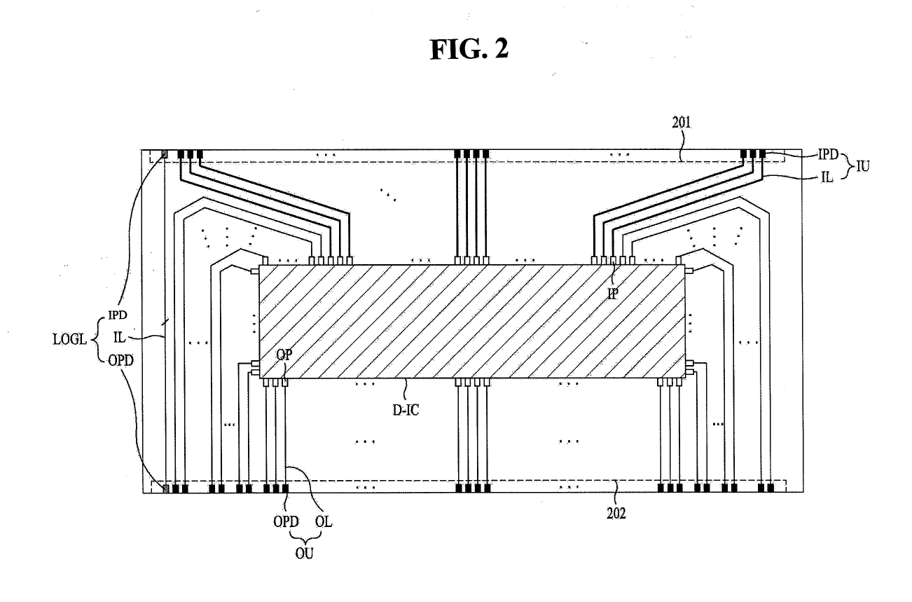

The driving circuit DRC of FIG. 1 will now be described in more detail with respect to FIG. 2. As shown in FIG. 2, the surface mounted type package TCP includes a mount region in which the driving integrated circuit D-IC is mounted in a Chip On Film (COF) manner, for example, a plurality of input patterns IU for connecting input pins IP of the driving integrated circuit D-IC to the external system, and a plurality of output patterns OU for connecting output pins OP of the driving integrated circuit D-IC to the panel PN. Further, in order to distinguish between the input patterns IU and the output patterns OU in FIG. 2, the thickness of input lines IL included in the input patterns IU is greater than that of output lines OL included in the output patterns OU. That is, for convenience, the thicknesses of the input lines and the output lines are differently shown in the drawing. However, the actual thicknesses of the input lines IL and the output lines OL may be set to be equal to each other.

In addition, each input pattern IU includes input pads IPD formed in an input pad portion 201 located on one end of the surface mounted type package TCP and the input lines IL for connecting the input pads IPD and the input pins IP. The output patterns OU connect the output pins OP of the driving integrated circuit D-IC to the panel PN, that is, the data lines DL of the panel PN, and each output pattern OU includes output pads OPD formed in an output pad portion 202 located on the other end of the surface mounted type package TCP and the output lines OL for connecting the output pads OPD and the output pins OP.

Further, in one example, a plurality of Line On Glass (LOG) type transmission patterns LOGL are formed in a left edge of the surface mounted type package TCP. The LOG type transmission patterns LOGL are also directly connected to LOG type signal transmission lines formed in the non-display unit ND of the panel PN without passing through the driving integrated circuit D-IC. In addition, the LOG type transmission patterns LOGL serve to supply a driving voltage, a ground voltage and the like supplied from the external system to the panel PN through the PCB. As shown, each of the LOG type transmission patterns LOGL includes an input pad IPD formed in the input pad portion 201, an output pad OPD formed in the output pad portion 202, and a transmission line IL for connecting the input pad IPD and the output pad OPD.

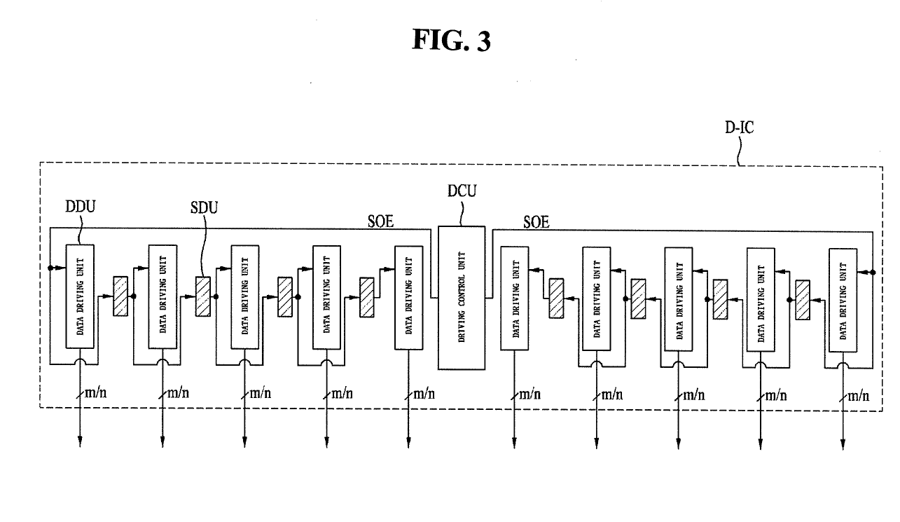

Next, FIG. 3 is a diagram showing more details of the driving integrated circuit D-IC according to an embodiment of the present invention. As shown in FIG. 3, the driving integrated circuit D-IC includes a driving control unit DCU, a plurality of data driving units DDUs and a plurality of signal delay/buffer units SDUs. In more detail, the plurality of data driving units DDUs supply image data to the display unit D through data link lines LK formed in the non-display unit ND (see FIG. 1). That is, the data driving units DDUs supply the image data to the data lines DL of the display unit D through the data link lines LK.

In addition, the driving control unit DCU aligns the image data from the external system, supplies the aligned image data to the data driving units DDUs, and generates a source output enable signal SOE for determining output timings of the image data from the data driving units DDUs. In particular, the driving control unit DCU first supplies the source output enable signal SOE to one or more data driving units DDUs connected to data link lines LK having a highest resistance among the data link lines LK such that one or more data driving units DDUs connected to the data link lines LK having the highest resistance among the data link lines LK outputs the image data earlier than the other data driving units DDUs.

In addition, the signal delay/buffer units SDUs are located between adjacent data driving units DDUs so as to delay and buffer a source output enable signal SOE supplied to a (k−1)-th data driving unit and to supply the delayed and buffered source output enable signal SOE to a k-th data driving unit.

FIG. 3 also shows an example of a relationship among the driving control unit DCU, the data driving units DDUs and the signal delay/buffer units SDUs. In particular, as shown in FIG. 3, n (n is an even number greater than or equal to 4) data driving units DDU are divided into two halves such that n/2 data driving units DDU are arranged on each of both sides of the driving control unit DCU. The data link lines LK are divided into a plurality of first link lines connected to the n/2 data driving units DDU arranged on one side of the driving control unit DCU and a plurality of second link lines connected to the n/2 data driving units DDU arranged on the other side of the driving control unit DCU.

In addition, because a resistance of the first and second link lines increases in proportion to the distance from the driving control unit DCU, a data driving unit DDU (hereinafter, referred to as a first outermost data driving unit DDU), which is farthest from the driving control unit DCU, among the n/2 data driving units DDUs arranged on one side of the driving control unit DCU is connected to a link line having the highest resistance among the first data link lines. Further, a data driving unit DDU (hereinafter, referred to as a second outermost data driving unit), which is farthest from the driving control unit DCU, among the n/2 data driving units DDUs arranged on the other side of the driving control unit DCU is connected to a link line having the highest resistance among the second data link lines.

In addition, the driving control unit DCU supplies the source output enable signal SOE to the first outermost data driving unit DDU and the second outermost data driving unit DDU earlier than the other data driving units DDUs. That is, the source output enable signal SOE output from the driving control unit DCU is first supplied to the first outermost data driving unit DDU and the second outermost data driving unit DDU, and is sequentially supplied to the data driving units DDUs arranged in a direction from the first outermost data driving unit DDU to the driving control unit DCU after being delayed and buffered through the signal delay/buffer units SDUs. The source output enable signal SOE is also sequentially supplied to the data driving units DDUs arranged in a direction from the second outermost data driving unit DDU to the driving control unit DCU after being delayed and buffered through the signal delay/buffer units SDU.

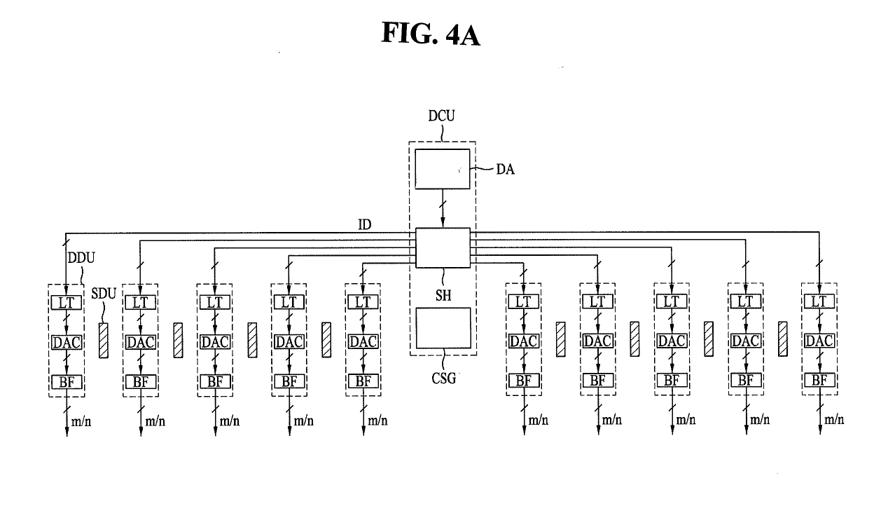

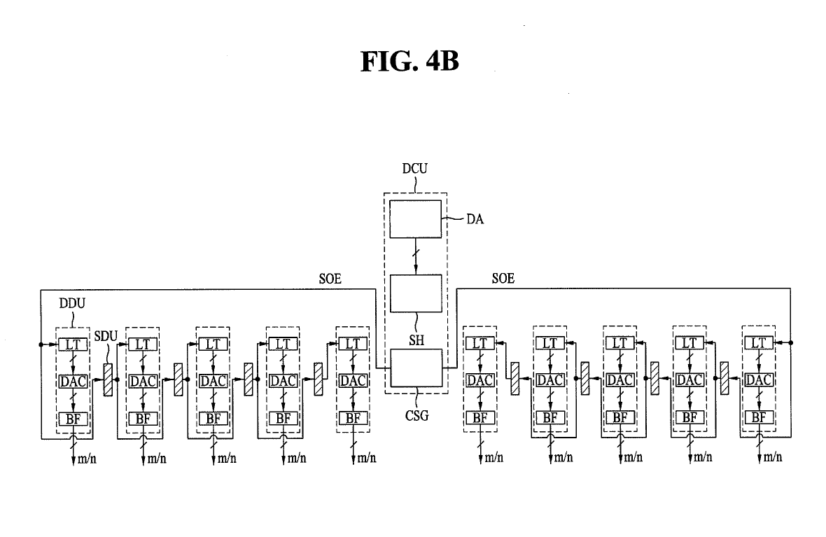

Hereinafter, the operation of the driving circuit according to an embodiment of the present invention will be described in more detail through the detailed structure of the driving control unit DCU and the data driving units DDUs. That is, FIGS. 4A and 4B are diagrams showing the driving control unit DCU and the data driving units DDUs of FIG. 3 in more detail.

As shown in FIGS. 4A and 4B, the driving control unit DCU includes a data alignment unit DA, a sample/hold unit SH and a control signal generation unit CSG. The data alignment unit DA realigns image data ID from the external system and outputs the realigned image data. The sample/hold unit SH sequentially samples and holds the image data ID from the data alignment unit DA. The sample/hold unit SH also divides n pieces of sampled image data by n/m pieces of sampled image data and simultaneously supplies the n/m pieces of sampled image data to each of m data driving units DDU.

Further, the control signal generation unit CSG receives a control signal from the external system and outputs various timing control signals including the source output enable signal SOE. Each data driving unit DDU also includes a latch LT, a digital/analog converter DAC, and a signal buffer BF. In more detail, the latch LT simultaneously receives m/n pieces of sampled image data ID among m (m=k*n; k is a natural number greater than or equal to 4) pieces of sampled image data from the sample/holding unit SH and simultaneously outputs m/n pieces of sampled image data ID in response to the source output enable signal SOE.

That is, n pieces of sampled image data ID stored in the sample/hold unit SH are equally divided and supplied to the latch LT of each data driving unit DDU, and the latch LT simultaneously outputs the sampled image data ID in response to the source output enable signal SOE from the control signal generation unit CSG. At this time, the first and second outermost data driving units DDUs, which are farthest from the driving control unit DCU, immediately receive the source output enable signal SOE from the control signal generation unit CSG, and the other data driving units DDU sequentially receive the source output enable signal SOE sequentially delayed by the signal delay/buffer unit SDU. Accordingly, the farther from the driving control unit DCU the data driving unit DDU is located, the earlier the source output enable signal SOE is received. Therefore, the farther from the driving control unit DCU the data driving unit DDU is located, the earlier the image data ID is output.

Therefore, because the image data is sequentially output in order from the data driving unit DDUs connected to the data link lines having a relatively high resistance to the data driving unit DDUs connected to the data link lines having a relatively low resistance, embodiments of the present invention minimize a luminance deviation between the pixels located on the central portion of the display unit D and the pixels located on both ends of the display unit D due to the sequential delay of the source output enable signal SOE so as to improve image quality.

In addition, the digital/analog converter DAC converts the m/n pieces of sampled image data ID from the latch LT into an analog signal, and the signal buffer BF buffers the m/n pieces of sampled image data ID from the digital/analog converter DAC and outputs the buffered image data.

Thus, because the length of the data link lines located on right and left ends of a display unit of the panel is greater than that of the data link lines located on a central portion of the display unit, a large resistance difference occurs between the link lines located on the central portion and the link lines located on both ends. Therefore, a distortion deviation between the image data output from the data driving units connected to the link lines located on the central portion and the image data output from the data driving units connected to the link lines located on both ends is increased. Thus, a large luminance difference is generated between the pixels located on the central portion of the display unit and the pixels located on both ends of the display unit.

The driving circuit for the display device and the method for driving the same according to embodiments of the present invention solve these problems. That is, in one embodiment of the present invention, the relatively less delayed and distorted source output enable signal is supplied to the data driving units connected to the pixels of both ends of the display unit and the relatively more delayed and distorted source output enable signal is supplied to the data driving units connected to the pixels of the central portion of the display unit. Therefore, the distortion degrees of the image data output from the data driving units located on the central portion of the display unit and the image data output from the data driving units located on both ends of the display unit become substantially equal to each other. Accordingly, embodiments of the present invention minimize the luminance deviation between the pixels of the central portion of the display unit and the pixels of the right and left ends of the display unit. Therefore, the image quality is significantly improved.

That is, the present invention provides a novel data driving circuit including a data driving circuit for a display panel, the data driving circuit including a driving integrated circuit (D-IC) including a plurality of data driving units (DDUs) configured to supply image data through a plurality of data link lines to data lines of the display panel and including a driving control unit (DCU) configured to generate a source output enable signal (SOE) for determining output timings of the image data from the data driving units (DDUs); and a package body (TCP) including a mount region (MD) in which the driving integrated (D-IC) circuit is mounted. Further, the driving control unit is further configured to first supply the source output enable signal (SOE) to a corresponding data driving unit (DDU) connected to a corresponding data link line having a greatest length among the data link lines such that the corresponding data driving unit outputs the image data earlier than other data driving units.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A data driving circuit for a display panel, the data driving circuit comprising:
a driving integrated circuit including a plurality of data driving units configured to supply image data through a plurality of data link lines to data lines of the display panel and including a driving control unit configured to generate a source output enable signal for determining output timings of the image data from the data driving units; and
a package body including a mount region in which the driving integrated circuit is mounted,
wherein the driving control unit is further configured to first supply the source output enable signal to a corresponding data driving unit connected to a corresponding data link line having a greatest length among the data link lines such that the corresponding data driving unit outputs the image data earlier than other data driving units.

2. The data driving circuit of claim 1, wherein the package body is disposed at a substantially upper center edge position of the display panel such that the data link lines extend from the substantially center edge position over a non-display unit to the data lines of a display unit of the display panel.

3. The data driving circuit of claim 1, wherein the driving control circuit is disposed between first and second sets of data driving units, and the data driving units are disposed spaced apart from one another in a direction away from the driving control circuit.

4. The data driving circuit of claim 3, wherein the driving control circuit first supplies the source output enable signals to the corresponding data units in the first and second set of data driving units that are farthest from the driving control circuit.

5. The data driving circuit of claim 4, wherein the driving control unit is further configured to delay the source output enable signals supplied to the corresponding data units in the first and second sets of data driving units that are farthest from the driving control circuit and supply the delayed source output enable signals to data driving units in the first and second sets of data driving units that are adjacent to the data driving units that are farthest from the driving control circuit.

6. The data driving circuit of claim 5, wherein the driving integrated circuit further comprises:
signal delay and buffer units between adjacent data driving units and configured to delay and buffer the source output enable signal supplied to a (k−1)-th data driving unit and to supply the delayed and buffered source output enable signal to a k-th data driving unit, and
wherein the (k−1)-th data driving units in the first and second sets of data driving units are the data driving units that are farthest from the driving control circuit.

7. The data driving circuit of claim 1, wherein the package body further comprises:
a plurality of input patterns for connecting input pins of the driving integrated circuit to a circuit board supplying image data and control signals to the driving integrated circuit; and
a plurality of output patterns for connecting the output pins of the driving integrated circuit to the display panel.

8. A display device, comprising:
a display panel including a non-display unit and a display unit and including a plurality of data and gate lines interesting each other; and
a data driving circuit for driving the display panel and including a driving integrated circuit including a plurality of data driving units configured to supply image data through a plurality of data link lines to the data lines of the display panel and including a driving control unit configured to generate a source output enable signal for determining output timings of the image data from the data driving units; and a package body including a mount region in which the driving integrated circuit is mounted,
wherein the driving control unit is further configured to first supply the source output enable signal to a corresponding data driving unit connected to a corresponding data link line having a greatest length among the data link lines such that the corresponding data driving unit outputs the image data earlier than other data driving units.

9. The display device of claim 8, wherein the package body is disposed at a substantially upper center edge position of the display panel such that the data link lines extend from the substantially center edge position over the non-display unit to the data lines of the display unit of the display panel.

10. The display device of claim 8, wherein the driving control circuit is disposed between first and second sets of data driving units, and the data driving units are disposed spaced apart from one another in a direction away from the driving control circuit.

11. The display device of claim 10, wherein the driving control circuit first supplies the source output enable signals to the corresponding data units in the first and second sets of data driving units that are farthest from the driving control circuit.

12. The display device of claim 11, wherein the driving control unit is further configured to delay the source output enable signals supplied to the corresponding data units in the first and second sets of data driving units that are farthest from the driving control circuit and supply the delayed source output enable signals to data driving units in the first and second sets of data driving units that are adjacent to the data driving units that are farthest from the driving control circuit.

13. The display device of claim 12, wherein the driving integrated circuit further comprises:
signal delay and buffer units between adjacent data driving units and configured to delay and buffer the source output enable signal supplied to a (k−1)-th data driving unit and to supply the delayed and buffered source output enable signal to a k-th data driving unit, and
wherein the (k−1)-th data driving units in the first and second sets of data driving units are the data driving units that are farthest from the driving control circuit.

14. The display device of claim 8, further comprising:
a circuit board supplying image data and control signals to the driving integrated circuit,
wherein the package body further comprises:
a plurality of input patterns for connecting input pins of the driving integrated circuit to the circuit board; and
a plurality of output patterns for connecting the output pins of the driving integrated circuit to the display panel.

15. A method of driving a display device having a display panel including a non-display unit and a display unit and including a plurality of data and gate lines interesting each other, the method comprising:
supplying, via a plurality of data driving units, image data through a plurality of data link lines to the data lines of the display panel; and
generating, via a driving control unit including a driving integrated circuit and a package body including a mount region in which the driving integrated circuit is mounted, a source output enable signal for determining output timings of the image data from the data driving units; and
first supplying the source output enable signal to a corresponding data driving unit connected to a corresponding data link line having a greatest length among the data link lines such that the corresponding data driving unit outputs the image data earlier than other data driving units.

16. The method of claim 15, wherein the package body is disposed at a substantially upper center edge position of the display panel such that the data link lines extend from the substantially center edge position over the non-display unit to the data lines of the display unit of the display panel.

17. The method of claim 15, wherein the driving control circuit is disposed between first and second sets of data driving units, and the data driving units are disposed spaced apart from one another in a direction away from the driving control circuit.

18. The method of claim 17, further comprising:
first supplying, via the driving control circuit, the source output enable signals to the corresponding data units in the first and second sets of data driving units that are farthest from the driving control circuit.

19. The method of claim 18, further comprising:
delaying, via the driving control unit, the source output enable signals supplied to the corresponding data units in the first and second sets of data driving units that are farthest from the driving control circuit; and
supplying, via the driving control unit, the delayed source output enable signals to data driving units in the first and second sets of data driving units that are adjacent to the data driving units that are farthest from the driving control circuit.

20. The method of claim 19, wherein the driving integrated circuit further includes signal delay and buffer units between adjacent data driving units, and
wherein the method further comprises:
delaying and buffering, via the signal delay and buffer units, the source output enable signal supplied to a (k−1)-th data driving unit and to supply the delayed and buffered source output enable signal to a k-th data driving unit, and
wherein the (k−1)-th data driving units in the first and second sets of data driving units are the data driving units that are farthest from the driving control circuit.

21. The method of claim 15, further comprising:
supplying image data and control signals, via a circuit board, to the driving integrated circuit,
wherein the package body further comprises:
a plurality of input patterns for connecting input pins of the driving integrated circuit to the circuit board; and
a plurality of output patterns for connecting the output pins of the driving integrated circuit to the display panel.
